(19) United States
(12) Patent Application Publication
(10) Pub. No.: US 2014/0078505 A1
(43) Pub. Date: Mar. 20, 2014

(54) OPTICAL DEVICE, METHOD OF FORMING AN OPTICAL DEVICE, AND METHOD FOR DETERMINING A PARAMETER OF A FLUID

(71) Applicant: Agency for Science, Technology and Research, Singapore (SG)

(72) Inventors: Yicheng Lai, Singapore (SG); Allan Chi Lun Wong, Singapore (SG); Seng-Tiong Ho, Singapore (SG)

(73) Assignee: Agency for Science, Technology and Research, Singapore (SG)

(21) Appl. No.: 14/030,296

(22) Filed: Sep. 18, 2013

Related U.S. Application Data
(60) Provisional application No. 61/702,276, filed on Sep. 18, 2012.

(51) Int. Cl. G02B 6/02; G01N 21/59

(52) U.S. Cl. CPC G02B 6/02052; G01N 21/59
USPC 356/440; 385/123; 216/24

(57) ABSTRACT

According to embodiments of the present invention, an optical device is provided. The optical device includes an optical fiber comprising a core for propagation of light and a cladding surrounding the core, and at least one microchannel defined in the optical fiber extending at least partially through the cladding, wherein the at least one microchannel has a concave-shaped surface arranged to interact with an optical field of the light. According to further embodiments of the present invention, a method of forming an optical device and a method for determining a parameter of a fluid are also provided.

### CROSS-REFERENCE TO RELATED APPLICATION

This application claims the benefit of priority of U.S. provisional application No. 61/702,276, filed 18 Sep. 2012, the content of it being hereby incorporated by reference in its entirety for all purposes.

### TECHNICAL FIELD

Various embodiments relate to an optical device, a method of forming an optical device and a method for determining a parameter of a fluid.

### BACKGROUND

The advent of femtosecond (fs) laser technology in recent years has enabled versatile high resolution micro-machining and micro-inscription in optical fibers. These engineered fiber devices inherit intrinsic advantages of optical fibers, while opening up device potentials that would otherwise be difficult to achieve with conventional optical fiber technology. For example, these devices include fs-laser inscribed fiber Bragg gratings for ultrahigh temperature (>1000° C.) operation and microchannel fiber devices for sensing applications. In particular, transverse microchannel optical fiber devices, i.e. fiber devices with microchannels orthogonal to its light propagation axis, are demonstrated to be potential candidates for various sensing applications, including biosensing. High quality uniform fiber microchannels are inscribed using fs-laser assisted with acid etching.

One of the key advantages of the microchannel fiber devices is the ability for the measurands (parameters to be measured) to be accessed at the core region where light intensity is the highest, thereby enhancing the sensing sensitivity and dynamic range. There are existing fiber devices schemes, namely photonic crystal fiber (PCF)-based, that similarly enable measurand access at the fiber core region through hollow core and micro-slot designs. However, difficulty in selectively filling or injecting liquids into the micro-holes, as well as large splice loss between PCF and standard single-mode fibers, where most optical instruments are designed with, remained as major challenges for practical implementation of these type of devices.

The introduction of a transverse microchannel through the core of an optical fiber can lead to high insertion loss due to optical scattering at the core-channel interface. The amount of scattering is a function of, among others, the channel index and such mechanism has been utilized for refractive index sensing applications. While this approach may be useful for straightforward power detection-based sensing, it is not possible to implement device configuration with serial array of microchannels for multiplexed operations due to excessive cumulative loss as light propagates through the channel array. In addition, to increase the detection sensitivity and dynamic range of the device, large differential power variation with the channel measurands will be necessary. Consequently, this can lead to very low transmitted power, hence low signal-to-noise ratio, on one end of the measurement range. Although the optical insertion loss can be reduced with narrow microchannel widths, its compromises the light-channel interaction length and volume of the measurands with the propagating light.

### SUMMARY

According to an embodiment, an optical device is provided. The optical device may include an optical fiber including a core for propagation of light and a cladding surrounding the core, and at least one microchannel defined in the optical fiber extending at least partially through the cladding, wherein the at least one microchannel has a concave-shaped surface arranged to interact with an optical field of the light.

According to an embodiment, a method of forming an optical device is provided. The method may include providing an optical fiber including a core for propagation of light and a cladding surrounding the core, and forming at least one microchannel in the optical fiber extending at least partially through the cladding, the at least one microchannel having a concave-shaped surface arranged to interact with an optical field of the light.

According to an embodiment, a method for determining a parameter of a fluid is provided. The method may include providing a fluid into at least one microchannel defined in an optical fiber including a core for propagation of light and a cladding surrounding the core, the at least one microchannel extending at least partially through the cladding and having a concave-shaped surface, providing a light into the core, wherein an optical field of the light interacts with the fluid, determining a transmission characteristic of the light after interaction between the optical field and the fluid, and determining a parameter of the fluid based on the determined transmission characteristic.

### BRIEF DESCRIPTION OF THE DRAWINGS

In the drawings, like reference characters generally refer to like parts throughout the different views. The drawings are not necessarily to scale, emphasis instead generally being placed upon illustrating the principles of the invention. In the following description, various embodiments of the invention are described with reference to the following drawings, in which:

FIG. 1A shows a schematic diagram of an optical device, according to various embodiments.

FIG. 1B shows a flow chart illustrating a method of forming an optical device, according to various embodiments.

FIG. 1C shows a flow chart illustrating a method for determining a parameter of a fluid, according to various embodiments.

FIG. 2A shows a schematic diagram of an optical device, according to various embodiments.

FIG. 2B shows a schematic cross-sectional view of a section of the optical device of FIG. 2A taken along a plane defined by the line A-A′.

FIG. 2C shows microscopy images at orthogonal view directions showing the femtosecond (fs) laser-inscribed 3-channel structure within a fiber, according to various embodiments.

FIG. 2D shows microscopy images at orthogonal view directions showing the removal of laser modified regions of the 3-channel structure of FIG. 2C, according to various embodiments.

FIG. 2E shows microscopy images at orthogonal view directions showing a final 3-channel cascaded transverse microchannel fiber device (TMFD) structure, according to various embodiments.

FIG. 3A shows a plot of transmission characteristics of a biconcave-shaped microchannel as a function of the radius of curvature of the microchannel, according to various embodiments.

FIG. 3B shows a plot of transmission characteristics of a biconcave-shaped microchannel as a function of the width of the microchannel, according to various embodiments.

FIG. 3C shows a plot of transmission characteristics of biconcave-shaped microchannels as a function of the channel separation between adjacent microchannels, according to various embodiments.

FIG. 4A shows simulation results showing light intensity distribution and transmitted power characteristics for a biconcave microchannel device structure, according to various embodiments.

FIG. 4B shows simulation results showing light intensity distribution and transmitted power characteristics for a rectangular microchannel device structure, according to various embodiments.

FIG. 5A shows simulation results showing light intensity distribution and transmitted power characteristics for a biconcave microchannel device structure with a microchannel length of about 210 μm, according to various embodiments.

FIG. 5B shows simulation results showing light intensity distribution and transmitted power characteristics for a rectangular microchannel device structure with a microchannel length of about 210 μm, according to various embodiments.

FIG. 6A shows simulation results showing light intensity distribution and transmitted power characteristics for a cascaded array of optimized biconcave microchannel device structure, according to various embodiments.

FIG. 6B shows simulation results showing light intensity distribution and transmitted power characteristics for a cascaded array of optimized rectangular microchannel device structure, according to various embodiments.

FIG. 7 shows a plot of insertion losses for a biconcave microchannel device structure and a rectangular microchannel device, as a function of the number of cascaded microchannels, according to various embodiments.

FIG. 8A shows respective plots of transmitted power for a biconcave microchannel device structure and a rectangular microchannel device, as a function of refractive index change in the range of 1-1.5, according to various embodiments.

FIG. 8B shows respective plots of transmitted power for a biconcave microchannel device structure and a rectangular microchannel device, as a function of refractive index change in the range of 1.333-1.4, according to various embodiments.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

Embodiments described in the context of one of the methods or devices are analogously valid for the other method or device. Similarly, embodiments described in the context of a method are analogously valid for a device, and vice versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element includes a reference to one or more of the features or elements.

In the context of various embodiments, the phrase “at least substantially” may include “exactly” and a reasonable variance.

In the context of various embodiments, the term “about” or “approximately” as applied to a numeric value encompasses the exact value and a reasonable variance.

As used herein, the term “and/or” includes any and all combinations of one or more of the associated listed items.

As used herein, the phrase of the form of “at least one of A or B” may include A or B or both A and B. Correspondingly, the phrase of the form of “at least one of A or B or C”, or including further listed items, may include any and all combinations of one or more of the associated listed items.

Various embodiments may relate to a microchannel optical fiber device configuration that may feature serially cascaded microchannels. Various embodiments of the device scheme may be applicable to passive and active device applications including but not limited to lasers, sensors and detectors.

Various embodiments may provide a low loss microchannel optical fiber device with large light-channel interaction surface and volume for active and passive device applications.

Various embodiments may provide a device scheme that may achieve low loss microchannel device configuration with a large light-channel interaction surface and a large light-channel interaction volume. The device concept of various embodiments may incorporate a series of cascaded microchannels with optimized dimensions, shapes and separations between them for maximum light-channel interaction and minimum insertion loss. The series of cascaded microchannels may be coupled to a fiber, e.g. coupled to the fiber core. The series of cascaded microchannels may be embedded with the fiber. As a non-limiting example, each microchannel may feature a biconcave shape in order to induce a lensing effect, enabling more light to be guided within the fiber core with less scattered light loss into the cladding of the fiber. With a low optical insertion loss property, in conjunction with a large light-channel interaction surface and volume, the microchannel fiber device concept of various embodiments may enable practical active and passive device schemes, not achievable before using conventional devices.

In various embodiments, multiplexing operation may be realized in such a microchannel fiber device configuration as the optical power may not be compromised by the cascaded array of channels or microchannels. It may be possible to incorporate one or more non-intrinsic materials, for example an optical gain medium or gain material such as a dye (e.g. an organic dye) into the microchannel array or one or more microchannels, such that fiber resonators with a high optical gain and a low insertion loss may be achieved, thereby enabling fiber laser operation. Therefore, fiber grating lasers not limited by the intrinsic fiber material may be realized with ease.

The microchannel device design of various embodiments may be incorporated into conventional active and passive fiber device schemes. Fiber devices such as fiber gratings may be inscribed in proximity to the microchannels to realize microchannel fiber grating devices. Also, as an example, the device concept of various embodiments may be incorporated into conventional distributed Bragg reflector (DBR) fiber grating laser design, thereby enabling ultra-high resolution microfluidic fiber laser sensors.

Further, materials such as magneto-optic materials and/or electro-optic materials may be incorporated into the microchannel fiber device of various embodiments, for example into the microchannel array or one or more microchannels, to manipulate or change the optical properties, such as polarization, of the light propagating through the microchannel fiber device.

Also, optical material such as a saturable absorber and/or a semiconductor material may be infused or provided into one or more microchannels to enable optical properties such as optical switching, spectral filtering or wavelength tuning Such integration of non-intrinsic materials into the microchannel fiber device may lead to at least one of light generation, light modulation/manipulation, or light detection, within the fiber device itself.

The device concept of various embodiments may provide localized transverse access into the fiber and may be applicable to all types of fibers, including but not limited to doped fibers and photonic crystal fibers.

Various embodiments may provide an optical device (e.g. an optical fiber device) having one or more microchannels formed therein. The optical device may include an optical fiber having a fiber core and a cladding. The microchannel(s) may extend close to the fiber core or at least partially into the core or extend through the core, across the entire diameter of the core. Further, the microchannel(s) may extend across the entire fiber, for example from one outer surface of the cladding to an opposed surface of the cladding.

In various embodiments, each microchannel may have at least one curved surface or shape (e.g. concave-shaped). Each microchannel may for example have a concave shape or a biconcave shape. In further embodiments, each microchannel may for example have a square or rectangular shape.

In various embodiments having a plurality of microchannels, the microchannels may be spaced apart. The microchannels may be arranged in cascade or in series. Each of the microchannels may have a concave shape, a biconcave shape or a rectangular shape. In further embodiments, the microchannels may have different shapes, selected from a concave shape, a biconcave shape or a rectangular shape.

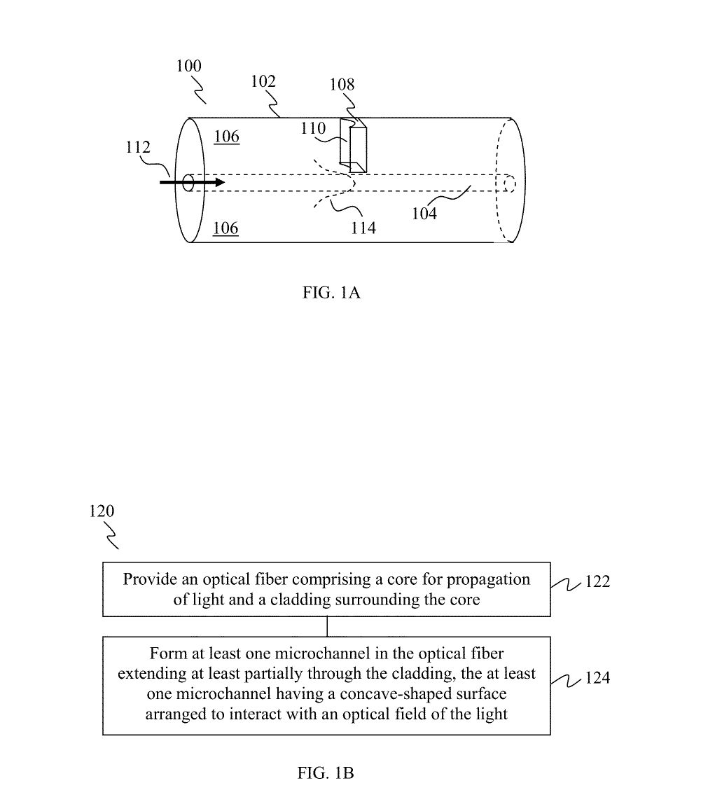

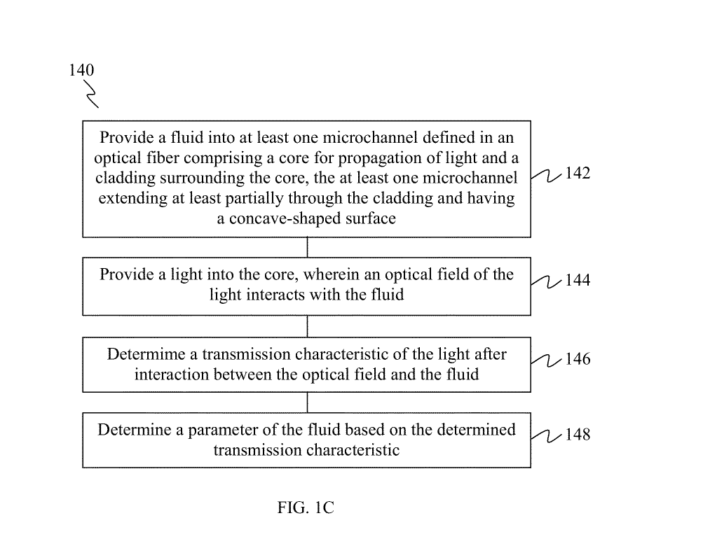

FIG. 1A shows a schematic diagram of an optical device 100, according to various embodiments. The optical device 100 includes an optical fiber 102 including a core 104 for propagation of light (as represented by arrow 112) and a cladding 106 surrounding the core 104, and at least one microchannel 108 defined in the optical fiber 102 extending at least partially through the cladding 106, wherein the at least one microchannel 108 has a concave-shaped surface 110 arranged to interact with an optical field (as represented by curve 114) of the light 112.

In other words, the optical device 100 may have an optical fiber 102. The optical fiber 102 may have a fiber core 104 where light 112 may at least substantially propagate in or through the core 104, and a cladding 106 encircling the core 104. The core 104 may have a refractive index (RI) that is higher than the refractive index (RI) of the cladding 106, so as to at least substantially confine the optical signal or light 112 in the core 104. The core 104 may be arranged centrally of the optical fiber 102. The optical device 100 may further include at least one microchannel 108 formed in the optical fiber 102, for example embedded within the optical fiber 102. The at least one microchannel 108 may extend at least partially into the cladding 106. The at least one microchannel 108 may extend from an outer diameter of the optical fiber 102 on one side of the optical fiber 102, through the cladding 106 towards the core 104. The at least one microchannel 108 may have a concave-shaped surface 110, where the concave-shaped surface 110 is arranged or positioned to interact or overlap with an optical field (or mode field or optical mode) 114 of the light 112. As illustrated in FIG. 1A, a tail of the optical field 114 may extend into the cladding 106 and may interact with the concave-shaped surface 110 of the at least one microchannel 108.

In various embodiments, the at least one microchannel 108 may be spaced a distance from the core 104. The at least one microchannel 108 may be arranged in proximity to the core 104 so that the concave-shaped surface 110 may interact with the optical field 114 of the light 112 propagating in the core 104. In this way, the at least one microchannel 108 may be offset or away from the core 104. Such an arrangement may, for example, induce polarization-dependent effects and/or to effectuate cladding devices.

In the context of various embodiments, the light 112 propagating in the core 104 may have an optical field 114 that may extend beyond the physical dimension or diameter of the guiding core 104. For example, the optical field 114 may be at least substantially maximum within the core 104, with a tail, containing optical power, that may extend out of the core 104, for example in the form of an evanescent field. Therefore, by arranging the at least one microchannel 108 in proximity to the core 104, the at least one microchannel 108 and its concave-shaped surface 110 may interact or overlap with the optical field 114 of the propagating light 112, by means of the evanescent field.

In the context of various embodiments, a “concave-shaped surface” may mean a surface that is at least substantially curved inwardly, in a direction towards the inside of the at least one microchannel 108.

In various embodiments, the concave-shaped surface 110, in interacting with an optical field (or mode field or optical mode) 114 of the light 112 propagating in the core 104, may act as a lens to induce a lensing or focusing effect, e.g. to focus the optical field 114. The concave-shaped surface 110 may enable reduced-scattering and/or a focal point to be provided within the at least one microchannel 108.

In various embodiments, the at least one microchannel 108 may extend at least partially into the core 104, wherein the concave-shaped surface 110 overlaps with the core 104. This may mean that the at least one microchannel 108 may extend from an outer diameter of the optical fiber 102 on one side of the optical fiber 102, through the cladding 106 and at least partially into the core 104. In this way, the concave-shaped surface 110 of the at least one microchannel 108 may interact with the optical field 114 in or within the core 104.

In various embodiments, the concave-shaped surface 110 of the at least one microchannel 108 may intersect with the core 104, such that the concave-shaped surface 110 may intersect the light 112 propagating in the core 104.

In various embodiments, the concave-shaped surface 110 of the at least one microchannel 108 may focus the light 112 propagating in the optical fiber 102, e.g. the light 112 propagating in the core 104.

In various embodiments, the concave-shaped surface 110 may reduce scattering of the light 112 within the at least one microchannel 108 and/or may focus the light 112 to a focal point within the at least one microchannel 108.

In various embodiments, the at least one microchannel 108 may pass through or extend across the core 104. This may mean that the at least one microchannel 108 may extend across the dimension or diameter of the core 104.

In various embodiments, the at least one microchannel 108 may extend through the cladding 106 on one side of the optical fiber 102, through the core 104 and at least partially into the cladding 106 on the opposite side of the optical fiber 102. This may mean that the at least one microchannel 108 may be accessed from one side of the optical fiber 102.

In various embodiments, the at least one microchannel 108 may extend through the cladding 106 on one side of the optical fiber 102, through the core 104 and through the cladding 106 on the opposite side of the optical fiber 102. This may mean that the at least one microchannel 108 may be accessed from opposite sides of the optical fiber 102.

In various embodiments, the surface of the at least one microchannel 108 opposite to the concave-shaped surface 110 may be at least substantially flat or planar. Therefore, the at least one microchannel 108 may have a plano-concave shape or geometry.

In various embodiments, the at least one microchannel 108 may have another concave-shaped surface opposite to the concave-shaped surface 110. Therefore, the at least one microchannel 108 may have a biconcave shape or geometry.

In various embodiments, the other concave-shaped surface may be arranged to interact or overlap with the optical field (or mode field) 114 of the light 112.

In embodiments where the at least one microchannel 108 extends at least partially into the core 104 and the concave-shaped surface 110 overlaps with the core 104, the other concave-shaped surface may also overlap with the core 104.

In various embodiments, the at least one microchannel 108 may be defined or formed orthogonally (or perpendicularly) to the core 104. This may mean that the at least one microchannel 108 may be defined transversely across the optical fiber 102, e.g. along a transverse axis perpendicular to the longitudinal axis of the optical fiber 102.

In various embodiments, the optical device 100 may further include an optical filter arranged adjacent or in proximity to the at least one microchannel 108. The optical filter may be provided overlapping or within the core 104.

In various embodiments, the optical filter may be in the form of a fiber grating, for example formed or defined in the core 104.

In various embodiments, the optical device 100 may include two optical filters (e.g. two fiber gratings) arranged on opposite sides of the at least one microchannel 108.

In the context of various embodiments, an optical gain medium may be arranged in the at least one microchannel 108. The optical gain medium may be a dye, for example an organic dye. In various embodiments, the dye may include but not limited to Rhodamine or Fluorescein.

By incorporating an optical gain medium, optical gain may be achieved in the optical device 100. Therefore, the optical device 100 may function as an optical resonator, e.g. a fiber resonator. The optical device 100 may enable laser operation.

In the context of various embodiments, at least one of a saturable absorber or a semiconductor material may be arranged in the at least one microchannel 108.

In the context of various embodiments, the term “saturable absorber” may mean an optical material where the absorption of light decreases with increasing light intensity.

In various embodiments, the saturable absorber may include but not limited to carbon (e.g. carbon nanotubes), indium gallium arsenide, or gallium arsenide.

In various embodiments, the semiconductor material may include but not limited to silicon, germanium, gallium arsenide, or indium phosphate.

In various embodiments, the incorporation of a saturable absorber and/or a semiconductor material may enable one or more optical properties such as optical switching, spectral filtering or wavelength tuning Such integration of non-intrinsic material(s) into the optical device 100 may lead to light generation and/or light modulation/manipulation and/or light detection within the optical device 100.

In the context of various embodiments, at least one of a magneto-optic material or an electro-optic material may be arranged in the at least one microchannel 108.

In the context of various embodiments, the term “magneto-optic material” may mean a material whose one or more optical properties may change in response to a magnetic field.

In various embodiments, the magneto-optic material may include but not limited to terbium doped borosilicate, terbium gallium garnet, or yttrium iron garnet.

In the context of various embodiments, the term “electro-optic material” may mean a material whose one or more optical properties may change in response to an electric field.

In various embodiments, the electro-optic material may include but not limited to lithium niobate, beta-barium borate, or potassium titanyl phosphate.

In various embodiments, the magneto-optic material and/or the electro-optic material may be employed to manipulate or tune one or more optical properties, such as polarization, of the light propagating through the optical fiber 102.

In the context of various embodiments, the concave-shaped surface 110 may be aspherical. In various embodiments, the other concave-shaped surface may be aspherical. An aspherical surface may provide for chromatic dispersion compensation.

In the context of various embodiments, at least one of the concave-shaped surface 110 or the other concave-shaped surface may have a radius of curvature, R, of between about 10 μm and about 30 μm, for example between about 10 μm and about 20 μm, between about 20 μm and about 30 μm, or between about 15 μm and about 25 μm, e.g. a radius of curvature of about 15 μm, about 20 μm, or about 30 μm.

In the context of various embodiments, a width, W, of the at least one microchannel 108 may be between about 10 μm and about 100 μm, for example between about 10 μm and about 50 μm, between about 10 μm and about 30 μm, or between about 20 μm and about 30 μm, e.g. a width of about 20 μm, about 24 μm, about 26 μm, about 30 μm, or about 50 μm. In various embodiments, the width of the at least one microchannel 108 may be larger than a diameter of the core 104.

In the context of various embodiments, a length, L, of the at least one microchannel 108 may be between about 20 μm and about 100 μm, for example between about 20 μm and about 50 μm, between about 20 μm and about 40 μm, or between about 20 μm and about 30 μm, e.g. a channel length, L, of about 20 μm, about 30 μm, about 40 μm, or about 50 μm.

In various embodiments, the optical device 100 may include a plurality of spaced apart microchannels 108 defined in the optical fiber 102 extending at least partially through the cladding 106, wherein each microchannel 108 of the plurality of spaced apart microchannels 108 has a concave-shaped surface 110 arranged to interact with the optical field 114 of the light 112.

In various embodiments, the plurality of spaced apart microchannels 108 may extend at least partially into the core 104, wherein the concave-shaped surface 110 of each microchannel 108 may overlap with the core 104.

In various embodiments, the plurality of spaced apart microchannels 108 may be arranged in series or in cascade along the optical fiber 102, meaning that the plurality of spaced apart microchannels 108 may be arranged one after another along the optical fiber 102.

It should be appreciated that any one of or each microchannel 108 of the plurality of spaced apart microchannels 108 may be as described above in the context of the at least one microchannel 108. Further, incorporation of material(s) such as the optical gain medium, the saturable absorber, etc. may be provided in any one of or each microchannel 108 of the plurality of spaced apart microchannels 108.

In various embodiments, the plurality of spaced apart microchannels 108 may be oriented at least substantially parallel to each other.

In the context of various embodiments, a sum, Lₛᵤₘ, of respective lengths, L, of the plurality of spaced apart microchannels 108 may be between about 40 μm and about 900 μm, for example between about 40 μm and about 500 μm, between about 100 μm and about 500 μm, between about 100 μm and about 300 μm or between about 150 μm and about 250 μm, e.g. a sum of about 100 μm, about 210 μm, about 500 μm, or about 900 μm.

In the context of various embodiments, a number of the plurality of spaced apart microchannels 108 may be between 2 microchannels and 30 microchannels, for example between 2 microchannels and 20 microchannels, between 2 microchannels and 10 microchannels, between about 5 microchannels and 20 microchannels or 5 microchannels and 10 microchannels, e.g. 5 microchannels, 7 microchannels, 10 microchannels, 20 microchannels or 30 microchannels.

In the context of various embodiments, adjacent microchannels 108 of the plurality of spaced apart microchannels 108 may be spaced apart by a separation, s, of between about 10 μm and about 100 μm, for example between about 40 μm and about 80 μm, between about 50 μm and about 70 μm, or between about 55 μm and about 65 μm, e.g. a separation of about 50 μm, about 54 μm, about 58 μm, about 64 μm, or about 70 μm.

In the context of various embodiments, the optical fiber 102 may be a single mode fiber.

In the context of various embodiments, the optical fiber 102 may be or may include a doped fiber or a photonic crystal fiber (PCF).

In various embodiments, a fluid (e.g. a liquid) may be provided into the at least one microchannel 108, or any one of or each of the plurality of spaced apart microchannels 108, so that the fluid may interact with the optical field 114 of the propagating light 112. Such an interaction may cause a change in an optical property of the light 112, e.g. a transmission characteristic or power of the light 112.

In the context of various embodiments, the optical device 100 may be a microchannel device, for example a microchannel optical fiber device.

In the context of various embodiments, the optical device 100 may be integrated on a substrate or a chip. In various embodiments, at least one of a reservoir, control means such as a valve, or delivery means such as a pump, interconnection(s), or microchannel(s) may be provided or integrated on the substrate or chip, for delivery and/or control of material (e.g. fluid or liquid) to the at least one microchannel 108 or the plurality of spaced apart microchannels 108.

FIG. 1B shows a flow chart 120 illustrating a method of forming an optical device, according to various embodiments.

At 122, an optical fiber including a core for propagation of light and a cladding surrounding the core is provided.

At 124, at least one microchannel is formed or defined in the optical fiber extending at least partially through the cladding, the at least one microchannel having a concave-shaped surface arranged to interact with an optical field of the light.

FIG. 1C shows a flow chart 140 illustrating a method for determining a parameter of a fluid, according to various embodiments.

At 142, a fluid is provided into at least one microchannel defined in an optical fiber including a core for propagation of light and a cladding surrounding the core, the at least one microchannel extending at least partially through the cladding and having a concave-shaped surface.

At 144, a light is provided into the core, wherein an optical field of the light interacts with the fluid. The optical field of the light may also interact with the concave-shaped surface of the at least one microchannel.

At 146, a transmission characteristic of the light after interaction between the optical field and the fluid is determined.

At 148, a parameter of the fluid is determined based on the determined transmission characteristic.

In various embodiments, the transmission characteristic may be the transmission power of the light.

In various embodiments, the parameter of the fluid may be the refractive index (RI).

While the method described above is illustrated and described as a series of steps or events, it will be appreciated that any ordering of such steps or events are not to be interpreted in a limiting sense. For example, some steps may occur in different orders and/or concurrently with other steps or events apart from those illustrated and/or described herein. In addition, not all illustrated steps may be required to implement one or more aspects or embodiments described herein. Also, one or more of the steps depicted herein may be carried out in one or more separate acts and/or phases.

Various embodiments may provide an optical fiber device with serially cascaded transverse microchannels passing through the fiber core. Each microchannel wall may feature a curved geometry to induce focusing lens effect, so as to reduce light scattering away from the fiber core. As a result, the transmitted power through the device may not be compromised by the number of cascaded microchannels. The curved geometries may include but not limited to biconcave and plano-concave shapes.

In various embodiments, a minimum optical insertion loss with maximum light-channel interaction may be achieved through optimized microchannel physical design. These optimized parameters may include dimensions, shapes as well as separations. For an identical channel volume that interacts with the propagating core light, the cascaded microchannels design concept of various embodiments may reduce the optical transmission loss by an order of magnitude as compared to a single-microchannel design.

The microchannel fiber device design or structure may be highly suited for biomedical applications as the transmission power loss with respect to the channel refractive index (RI) in the range of 1.333-1.4 may be very low.

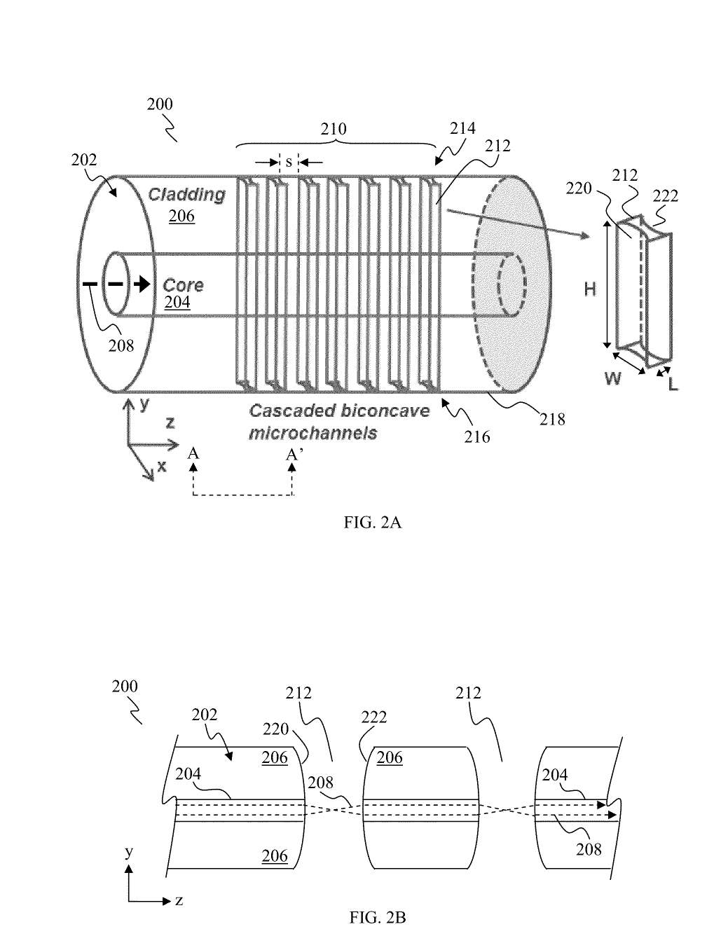

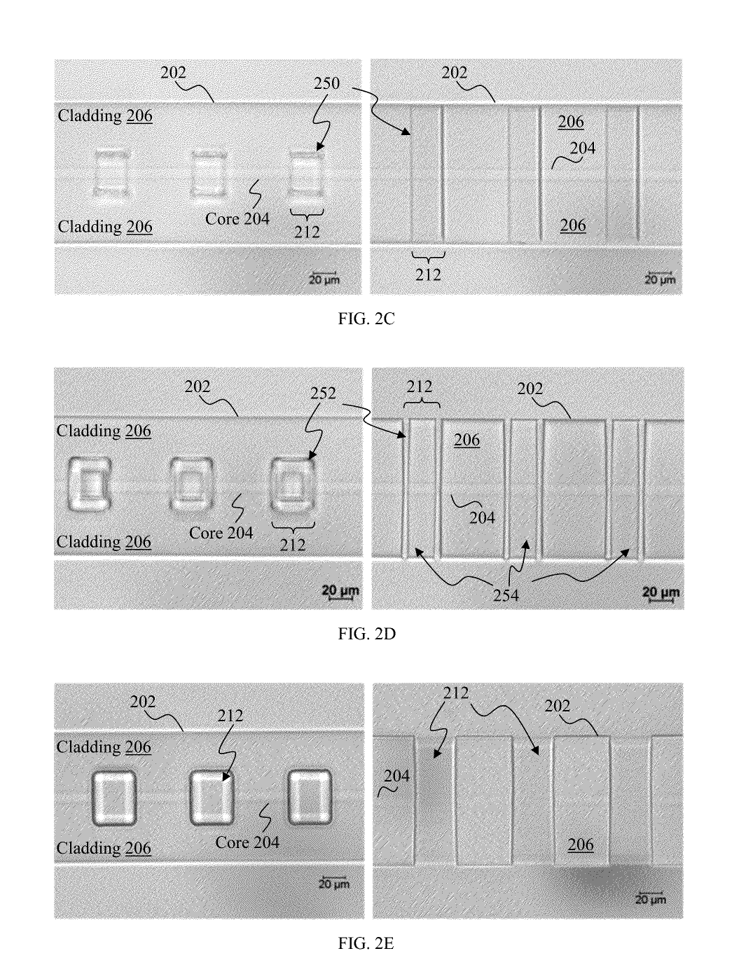

FIG. 2A shows a schematic diagram of an optical device 200, according to various embodiments, illustrating a microchannel fiber device. The optical device 200 includes an optical fiber 202 having a core 204 surrounded by a cladding 206. The size of the core 204 is exaggerated compared to the size of the cladding 206 for clarity purposes. As illustrated in FIG. 2A, the fiber 202 may have a longitudinal axis along the z-direction. A light provided to the optical device 200, for example to the optical fiber 202, may propagate through the core 204 (the propagating light represented as the dashed line arrow 208), at least substantially within the core. This may mean that the optical field or the power of the propagating light 208 may be at least substantially contained within the core 204 or overlap with the core 204. The light 208 may propagate along the longitudinal axis of the fiber 202.

The optical device 200 may include a microchannel array 210 defined in the fiber 202. The microchannel array 210 may include one or more microchannels formed or defined in the fiber 202, for example embedded in the fiber 202. As a non-limiting example as illustrated in FIG. 2A, the microchannel array 210 may have 7 microchannels, as represented by 212 for one such microchannel. However, it should be appreciated that any number of microchannels 212 may be provided, for example one, two, three, four or any higher number of microchannels 212.

Referring to FIG. 2A, the plurality of microchannels 212 may be arranged along the longitudinal axis of the fiber 202. The plurality of microchannels 212 may be arranged at least substantially parallel relative to each other. The plurality of microchannels 212 may be spaced apart, such that adjacent microchannels 212 may be separated by a separation distance, s. The plurality of microchannels 212 may be arranged in series or in cascade, one after another. Therefore, the optical device 200 may have a cascaded microchannel fiber device design.

Each microchannel 212 may pass through the fiber core 204. For example, the optical device 200 may include serially cascaded microchannels 212 passing through the fiber core 204. In various embodiments, each microchannel 212 may have opposed surfaces, for example a first surface 220 and a second surface 222, arranged facing the core 204. In this way, a respective portion of each of the first surface 220 and the second surface 222 may form a respective interface with the core 204. This may also mean that a respective portion of each of the first surface 220 and the second surface 222 may overlap with or intersect the core 204. Therefore, the light 208 propagating through the core 204 may also pass through the microchannel array 210, through each microchannel 212. In various embodiments, each microchannel 212 may be defined across the entire core 204.

Each microchannel 212 may be defined through the cladding 206, for example across the entire cladding 206. Therefore, in various embodiments, each microchannel 212 may be defined through the diameter of the fiber 202, extending between two opposed sides 214, 216, of the peripheral surface 218 of the fiber 202.

Each microchannel 212 may be arranged transversely across the fiber 202, along a transverse axis that is perpendicular to the longitudinal axis of the fiber 202. This may mean that each microchannel 212 may be positioned orthogonal to the core 204 or the light propagation axis along the core 204. In this way, the first surface 220 and the second surface 222 of each microchannel 212 may be arranged at least substantially perpendicular to the core 204 or the light propagation axis. However, it should be appreciated that any one or more or all of the plurality of spaced apart microchannels 212 may be arranged slightly angled to the transverse axis, for example about 1° to 10° offset from the transverse axis.

Each microchannel 212 may be defined by its height, H, defined along the y-direction, its width, W, defined along the x-direction, and its length, L, defined along the z-direction. Each microchannel 212 may have a biconcave shape. This may mean that each microchannel 212 may have two opposed surfaces that may be curved inwardly into the microchannel 212, in the form of a concave shape. Referring to FIG. 2, each microchannel 212, of a biconcave shape, may have a first surface 220 that may be curved and a second surface 222 that may be curved. The channel length, L, of each microchannel 212 may be defined as the distance between the first surface 220 and the second surface 222. Each of the first surface 220 that and the second surface 222 may be curved across the entire respective surface. The first surface 220 and the second surface 222 may be curved inwardly into the microchannel 212, such that the first surface 220 and the second surface 222 may be curved towards each other, thereby defining concave shapes. Therefore, the light 208 propagating in the core 204 may encounter the first surface 220 that is curved away from the light 208, and then the second surface 222 that is curved towards the light 208. In various embodiments, by having a biconcave shape, each microchannel, aided by its geometry, may focus the propagating light 208 within the core 204. In this way, minimal or no light may be lost through the cladding 206. Therefore, in various embodiments, the optical device 200 may include an array of biconcave microchannels 212 positioned orthogonal to its light propagation axis along the core 204. The microchannels 212 may extend through the fiber cladding 206, passing through the fiber core 204. Each microchannel 212 may reduce scattering of the light 208 within the microchannel 212 and/or may focus the light 208 to a focal point within the microchannel 212.

FIG. 2B shows a schematic cross-sectional view of a section of the optical device 200 taken along a plane defined by the line A-A′. The size of the light 208 is exaggerated for ease of understanding to illustrate the focusing effect induced by the geometry of the biconcave microchannels 212. As the light 208 propagates in the core 204, the light 208 encounters the first surface 220 of the biconcave microchannel 212. From the perspective of the light 208, the light 208 sees the first surface 220 as a convex surface or shape, complementary to the concave shape or geometry of the microchannel 212. Therefore, the light 208 propagating into the microchannel 212 may, as a result of the lensing effect, be significantly less scattered and/or even focused within the microchannel 212. As the light 208 passes through the microchannel 212, the light 208 encounters the second surface 222 of the biconcave microchannel 212. From the perspective of the light 208, the light 208 sees the second surface 220 as a convex surface or shape, complementary to the concave shape of the microchannel 212, and the light 208 become coupled and propagate within the core 204. Such a lensing or focusing effect may be enabled by each biconcave microchannel 212 of the optical device 200.

While FIGS. 2A and 2B show that the entire first surface 220 is curved (concave-shaped) and the entire second surface 222 is curved (concave-shaped) for each microchannel 212, it should be appreciated that in further embodiments, the portion of the first surface 220 overlapping with the core 204 may be curved (concave-shaped) while the remaining portion of the first surface 220 may be at least substantially flat or planar, and the portion of the second surface 222 overlapping with the core 204 may be curved (concave-shaped) while the remaining portion of the second surface 222 may be at least substantially flat or planar, for one or more of the microchannels 212.

While it is shown in FIGS. 2A and 2B that the optical device 200 includes a plurality of biconcave microchannels 212 as an illustrative example embodiment, it should be appreciated that optical devices with different configurations may be provided, for example having a single biconcave microchannel, or a single plano-concave microchannel, or a plurality of plano-concave microchannels, or a plurality of rectangular microchannels, or a combination of biconcave microchannel(s) and/or plano-concave microchannel(s) and/or rectangular microchannel(s).

Fabrication of the optical device of various embodiments will now be described by way of the following non-limiting example. The optical device (e.g. microchannel fiber device) may be realized through a hydrofluoric acid (HF) etching-assisted femtosecond (fs) laser processing fabrication methodology.

The process may include two main steps: (1) inscription of the desired structure (e.g. the channel structure) into the fiber by using a tightly focused femtosecond laser beam, and (2) etching of the fiber in a solution of 8% hydrofluoric acid (HF) for selective removal of the laser-modified regions.

In the laser inscription process, the femtosecond laser pulses, having a center wavelength of about 830 nm, may be focused into a fiber (e.g. a silica fiber) by using an objective lens with a numerical aperture (NA) of about 0.55 and a working distance of about 4 mm. The laser pulse width may be about 150 fs, and the repetition rate may be at about 100 kHz. The focused spot size diameter may be approximately 1 μm, with an average pulse energy at about 100 nJ. The fiber may be mounted on a three-axes air-bearing translation stage, so that the desired microchannel structure may be inscribed into the fiber by moving the fiber with respect to the stationary laser beam of the femtosecond laser. The translation velocity of the fiber may be maintained at about 80 μm/s. The laser inscription process may involve a continuous helical rectangular path along the transverse axis of the fiber to create the microchannel structure. FIG. 2C shows microscopy images illustrating a top view (left image) and a side view (right image) of a fiber 202 with a femtosecond-inscribed 3-channel structure, where the laser modified regions, as represented by 250, may allow for eventual formation of microchannels 212.

Subsequently, the femtosecond-inscribed fiber 202 may be subjected to a HF etching process for a duration of about 30 minutes, which thereafter may reveal the removal of the laser modified regions 250. FIG. 2D shows microscopy images illustrating a top view (left image) and a side view (right image) of the fiber 202 after the HF etching process, which show the removal of the laser modified regions 250 of the 3-channel structure through HF etching. As shown in FIG. 2D, there are HF removed regions 252, as well as residual fiber material 254 at portions where the microchannels 212 are to be formed.

Ultrasonic bath treatment of the fiber may be carried out in water, which may lead to the final microchannel device as shown in FIG. 2E, which shows microscopy images illustrating a top view (left image) and a side view (right image) of a completed 3-channel cascaded transverse microchannel fiber device (TMFD) structure. As shown in FIG. 2D, etched microchannels 212 are formed in the fiber 202.

It should be appreciated that the fabrication methodology as described is independent of the microchannel geometry as well as the number of microchannels. This means that the process may be used to form one or more microchannels of any geometry or shape.

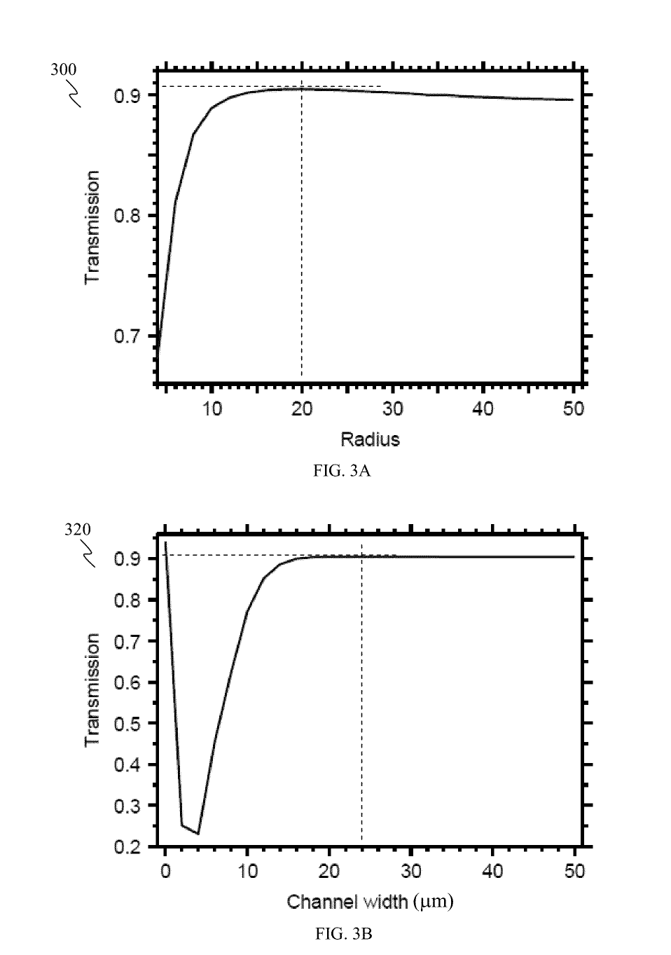

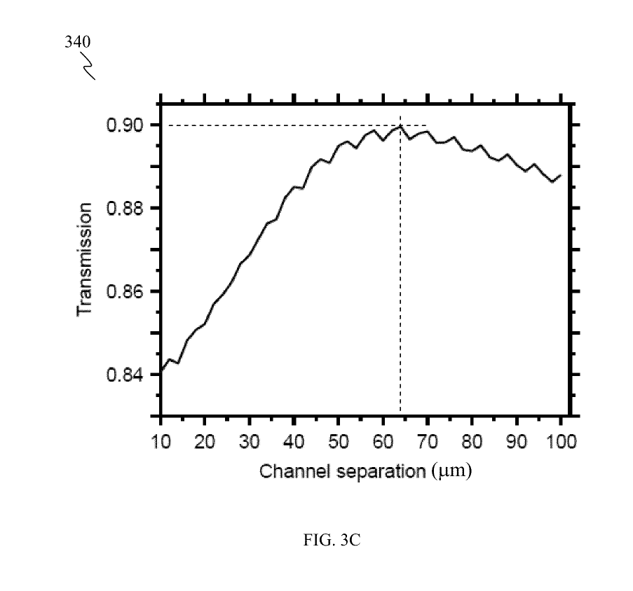

Microchannel optimization will now be described by way of the following non-limiting examples, with reference to FIGS. 3A to 3C. For the purpose of simulations, the following global parameters may be used: launch wavelength of about 1550 nm; core and cladding diameters of about 8.39 μm and about 125 μm, respectively; core and cladding refractive indices (RIs) of about 1.4503 and about 1.4436, respectively; microchannel RIs set to about 1.3333, meaning that a fluid having a RI of about 1.3333 is introduced or contained in the microchannel. With these parameters, the input light power confined within the fiber mode field diameter may be about 94.17%, and the insertion loss may be calculated by: Loss=(0.9417−T)/0.9417, where T is the transmitted power. The extended fiber length may be fixed at about 2 mm from the end-face of the last microchannel. The optimal parameter value for each microchannel may be chosen such that the transmitted power is maximum.

Optimization of the dimension of a microchannel will now be described. An individual microchannel length, L, of about 30 μm may be considered. The microchannel shape may be of the curved-lens type that may induce a focusing effect, and therefore the biconcave shape may be employed. In this regard, the radius of curvature, R, may be a property that may influence the focusing effect, and hence, the amount of transmitted power. It may be set to be in the range of W/2≦R≦∞, where ∞ refers to a flat surface, with the width, W, and the length, L, of the microchannel set to about 26 μm and about 30 μm, respectively. FIG. 3A shows a plot 300 of transmission characteristics of a biconcave-shaped microchannel as a function of the radius of curvature, R, of the microchannel, according to various embodiments. As may be observed, the transmission increases with the radius of curvature, R, up to a maximum value of approximately 0.91 at R of approximately 20 μm, and then decreases monotonically thereafter. Thus, the optimal radius of curvature, Rₒₚₜ, may be chosen to be about 20 μm.

The width, W, of the microchannel may be studied by varying the width, W, for a fixed radius of curvature, R, of about 20 μm, as well as a fixed channel length, L, of about 30 μm. FIG. 3B shows a plot 320 of transmission characteristics of a biconcave-shaped microchannel as a function of the width of the microchannel, according to various embodiments. As may be observed, when the width, W, of the microchannel is less than the fiber core size of about 8.39 μm, the microchannel may induce a large scattering loss and thus, a low transmitted power. The transmission increases with the width, W, and stabilizes to a maximum value of approximately 0.91 for a channel width, W, of approximately 24 μm, which therefore may be taken to be the optimal width, Wₒₚₜ, for the biconcave microchannel.

Optimization of channel separation will now be described. The channel separation, s, is the distance between two adjacent microchannels, and may be studied by monitoring the transmitted power after passing through two serially cascaded channels. FIG. 3C shows a plot 340 of transmission characteristics of biconcave-shaped microchannels as a function of the channel separation between adjacent microchannels, according to various embodiments. As may be observed, the transmission characteristic is similar to that for the radius of curvature, R. The transmission increases with the separation, s, up to a maximum value of approximately 0.9 at separation of approximately 64 μm, and then decreases thereafter. Thus, the optimal separation, sₒₚₜ, is approximately 64 μm.

With the optimized physical parameters for the biconcave microchannels, a performance comparison may be carried out, for example a comparative study on the power transmission characteristics between: (i) a biconcave and a rectangular microchannel of identical channel length, and between (ii) a single long-length microchannel and an optimized microchannel array.

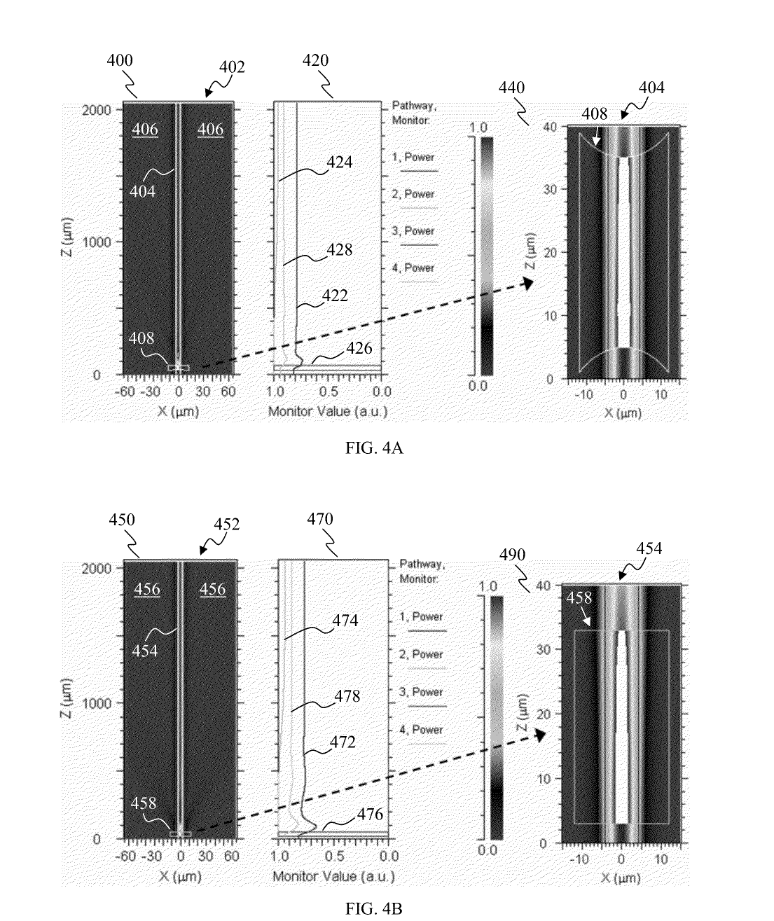

Performances relating to an optical device having a single optimized channel will now be described by way of the following non-limiting examples. FIGS. 4A and 4B compare the light intensity distribution and the transmitted power between a single biconcave microchannel optical device and a single rectangular microchannel optical device of the same physical channel length, L, of about 30 μm.

FIG. 4A shows a plot 400 of simulated light intensity distribution and a plot 420 of simulated transmitted power characteristics for a biconcave microchannel device structure 402, according to various embodiments. As shown in plot 400, the optical device 402 includes an optical fiber having a core 404 and a cladding 406. The optical device 402 further includes a single biconcave microchannel 408 extending through the core 404, perpendicular to the core 404. The plot 440 shows the simulated light intensity distribution in the vicinity of or around the biconcave microchannel 408.

The plot 420 shows result 422 representing the power distribution within the core 404 (e.g. core power variation along the length of the fiber), result 424 representing the power distribution within the core 404 and the cladding 406 (e.g. core and cladding power variation along the length of the fiber) and result 426 representing the power distribution within the microchannel 408. The plot 420 also shows result 428 illustrating the power distribution within the mode field diameter of the propagating optical mode.

FIG. 4B shows a plot 450 of simulated light intensity distribution and a plot 470 of transmitted power characteristics for a rectangular microchannel device structure 452, according to various embodiments. As shown in plot 450, the optical device 452 includes an optical fiber having a core 454 and a cladding 456. The optical device 452 further includes a single rectangular microchannel 458 extending through the core 454, perpendicular to the core 454. The plot 490 shows the simulated light intensity distribution in the vicinity of or around the rectangular microchannel 458.

The plot 470 shows result 472 representing the power distribution within the core 454 (e.g. core power variation along the length of the fiber), result 474 representing the power distribution within the core 454 and the cladding 456 (e.g. core and cladding power variation along the length of the fiber) and result 476 representing the power distribution within the microchannel 458. The plot 470 also shows result 478 illustrating the power distribution within the mode field diameter of the propagating optical mode.

Based on the simulation results, the insertion losses introduced by the biconcave microchannel 408 and the rectangular microchannel 458 are about 3.74% and about 6.49%, respectively. That is, for a single optimized microchannel, the focusing effect of the biconcave microchannel 408 may reduce the loss by approximately 2.75%. The in-fiber biconcave-shape of the microchannel 408 may act like two focusing lenses since the microchannel 408 may have a lower refractive index (RI) than that of the fiber core 404. The focusing may effectively reduce the amount of scattered light loss into the cladding 406, thereby achieving a lower overall transmission loss.

While the benefit of the focusing effect may not seem to be significant for a single microchannel configuration, there may be a large transmission loss improvement when multiple channels are cascaded together as will be described later below.

Performances relating to an optical device having a single channel with a long channel length will now be described by way of the following non-limiting examples.

The respective lengths of the biconcave microchannel 408, as shown in FIG. 4A, and the rectangular microchannel 458, as shown in FIG. 4B, provide a relatively short light-channel interaction length. Consequently, measurand(s) within the respective microchannels 408, 458 may not produce significant perturbation to the interacting light in the respective fiber cores 404, 454, which may limit their practical use, for example, as effective microfluidic sensors. As a non-limiting example, in order to increase the light-channel interaction length, the channel length may be increased to, for example, 210 μm, which may be equivalent to 7 times of the desired length.

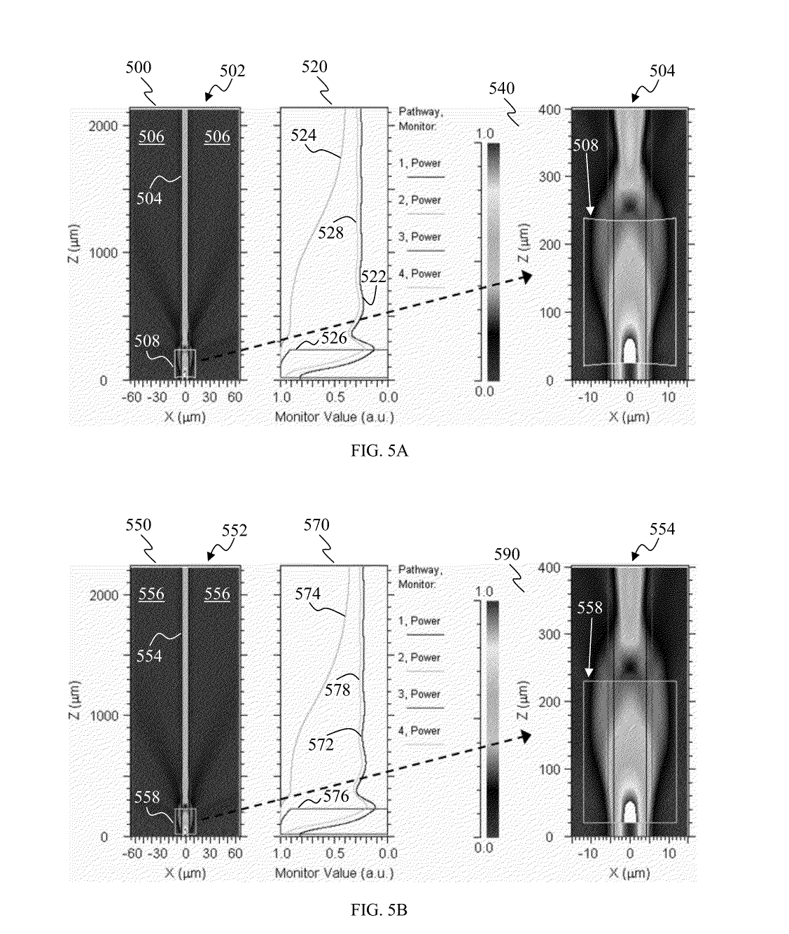

FIGS. 5A and 5B show the light intensity distribution and the transmitted power of a biconcave microchannel optical device and a rectangular microchannel optical device, respectively, where each optical device includes a microchannel having a channel length, L, of about 210 μm.

FIG. 5A shows a plot 500 of simulated light intensity distribution and a plot 520 of simulated transmitted power characteristics for a biconcave microchannel device structure 502, according to various embodiments. As shown in plot 500, the optical device 502 includes an optical fiber having a core 504 and a cladding 506. The optical device 502 further includes a single biconcave microchannel 508 extending through the core 504, perpendicular to the core 504, where the biconcave microchannel 508 has a channel length of about 210 μm. The plot 540 shows the simulated light intensity distribution in the vicinity of or around the biconcave microchannel 508.

The plot 520 shows result 522 representing the power distribution within the core 504 (e.g. core power variation along the length of the fiber), result 524 representing the power distribution within the core 504 and the cladding 506 (e.g. core and cladding power variation along the length of the fiber) and result 526 representing the power distribution within the microchannel 508. The plot 520 also shows result 528 illustrating the power distribution within the mode field diameter of the propagating optical mode.

FIG. 5B shows a plot 550 of simulated light intensity distribution and a plot 570 of transmitted power characteristics for a rectangular microchannel device structure 552, according to various embodiments. As shown in plot 550, the optical device 552 includes an optical fiber having a core 554 and a cladding 556. The optical device 552 further includes a single rectangular microchannel 558 extending through the core 554, perpendicular to the core 554, where the rectangular microchannel 558 has a channel length of about 210 μm. The plot 590 shows the simulated light intensity distribution in the vicinity of or around the rectangular microchannel 558.

The plot 570 shows result 572 representing the power distribution within the core 554 (e.g. core power variation along the length of the fiber), result 574 representing the power distribution within the core 554 and the cladding 556 (e.g. core and cladding power variation along the length of the fiber) and result 576 representing the power distribution within the microchannel 558. The plot 570 also shows result 578 illustrating the power distribution within the mode field diameter of the propagating optical mode.

The respective insertion losses in both cases of the biconcave microchannel optical device 502 and the rectangular microchannel optical device 552 increases up to about 69.38% and about 72.58% respectively based on the simulation results.

Performances relating to an optical device having cascaded channels with a long effective light-channel interaction length will now be described by way of the following non-limiting examples.

In order to address or overcome the issue of large optical insertion loss while maintaining a long light-channel interaction length, a device configuration which contains multiple microchannels cascaded serially along the fiber may be provided. The microchannel separations in the array structure may be of an optimized distance. For example, for a sum or total effective light-channel interaction length, Lₛᵤₘ, of about 210 μm, 7 microchannels may be provided, each microchannel having a length of 30 μm, with optimized separation distances of about 54 μm provided for biconcave microchannels and optimized separation distances of about 58 μm provided for rectangular microchannels.

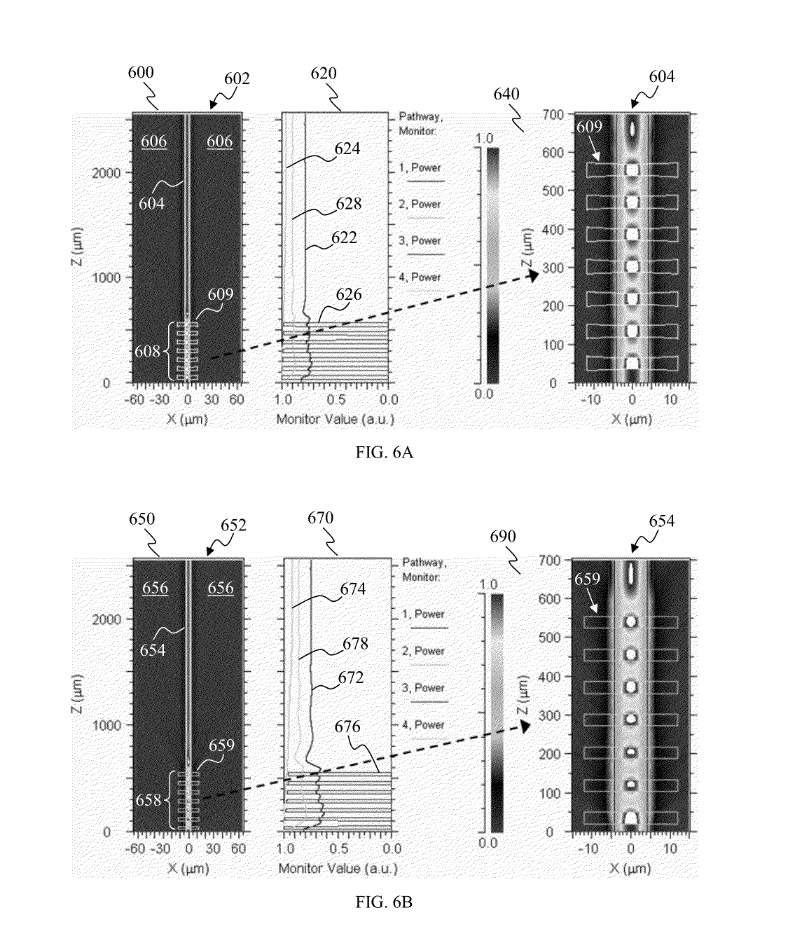

FIGS. 6A and 6B show the light intensity distribution and the transmitted power of a biconcave microchannel array device structure and a rectangular microchannel array device structure, respectively, where each microchannel array device structure has a total effective light-channel interaction length, Lₛᵤₘ, of about 210 μm.

FIG. 6A shows a plot 600 of simulated light intensity distribution and a plot 620 of simulated transmitted power characteristics for an optimized biconcave microchannel device structure 602 with a cascaded array 608 of microchannels, as represented by 609 for one biconcave microchannel, according to various embodiments. As shown in plot 600, the optical device 602 includes an optical fiber having a core 604 and a cladding 606. The optical device 602 further includes an array 608 of spaced apart microchannels 609 arranged in series extending through the core 604, perpendicular to the core 604. As a non-limiting example, the microchannel array 608 includes 7 biconcave microchannels 609, each microchannel 609 having a channel length of about 30 μm, thereby providing a total effective channel length of about 210 μm for interaction with light. The plot 640 shows the simulated light intensity distribution in the vicinity of or around the biconcave microchannel array 608.

The plot 620 shows result 622 representing the power distribution within the core 604 (e.g. core power variation along the length of the fiber), result 624 representing the power distribution within the core 604 and the cladding 606 (e.g. core and cladding power variation along the length of the fiber) and result 626 representing the power distribution within the microchannels 609. The plot 620 also shows result 628 illustrating the power distribution within the mode field diameter of the propagating optical mode.

FIG. 6B shows a plot 650 of simulated light intensity distribution and a plot 670 of simulated transmitted power characteristics for an optimized rectangular microchannel device structure 652 with a cascaded array 658 of microchannels, as represented by 659 for one rectangular microchannel, according to various embodiments. As shown in plot 650, the optical device 652 includes an optical fiber having a core 654 and a cladding 656. The optical device 652 further includes an array 658 of spaced apart microchannels 659 arranged in series extending through the core 654, perpendicular to the core 654. As a non-limiting example, the microchannel array 658 includes 7 rectangular microchannels 659, each microchannel 659 having a channel length of about 30 μm, thereby providing a total effective channel length of about 210 μm for interaction with light. The plot 690 shows the simulated light intensity distribution in the vicinity of or around the rectangular microchannel array 658.

The plot 670 shows result 672 representing the power distribution within the core 654 (e.g. core power variation along the length of the fiber), result 674 representing the power distribution within the core 654 and the cladding 656 (e.g. core and cladding power variation along the length of the fiber) and result 676 representing the power distribution within the microchannels 659. The plot 670 also shows result 678 illustrating the power distribution within the mode field diameter of the propagating optical mode.

Based on the device configurations of the optical devices 602, 652, the overall insertion losses for the biconcave channel array optical device 602 and the rectangular channel array optical device 652 are about 4.92% and about 8.71%, respectively. It is evident that there is a marked improvement in the power transmission over that of a single long-length microchannel device scheme for the optical devices 502, 552. Further, compared to the device configuration using a single, long microchannel length, the loss reduction reaches an order of magnitude based on the biconcave microchannel array device 602.

With a low optical insertion loss property, the microchannel fiber device concept of various embodiments may enable practical active and passive device schemes, not achievable before. For example, multiplexing operation may be realized in such a microchannel fiber device configuration since the optical power may not be compromised by the cascaded array of channels. Such a multiplexing operation may include (a) having multiple simultaneous operations e.g. fluid detections, from individual channels within one microchannel fiber device, and/or (b) having simultaneous operations from two or more microchannel fiber devices cascaded in series. Multiplexing operation may be achieved for microchannel fiber devices cascaded in series through, for example incorporating wavelength-selective fiber gratings in proximity to each microchannel fiber device. By doing so, the respective optical response due to each microchannel fiber device may be differentiated based on the spectral responses.

In various embodiments, by incorporating a gain material such as a dye into the microchannel array, fiber resonators with high optical gain and low insertion loss may be achieved, enabling fiber laser operation where intra-cavity loss for lasing action may be <10%. Henceforth, fiber grating lasers which may not be limited by the intrinsic fiber material may be realized with ease.

Furthermore, the microchannel device design of various embodiments may be incorporated into conventional active and passive fiber device schemes. For example, the optical device or the device concept of various embodiments may be incorporated into conventional DBR fiber grating laser designs for enabling ultra-high resolution microfluidic fiber laser sensors.

Optimization of the cascaded microchannel fiber device design of various embodiments will now be described by way of the following non-limiting examples. The number of microchannels a device structure may accommodate without compromising a pre-determined overall insertion loss value may be determined.

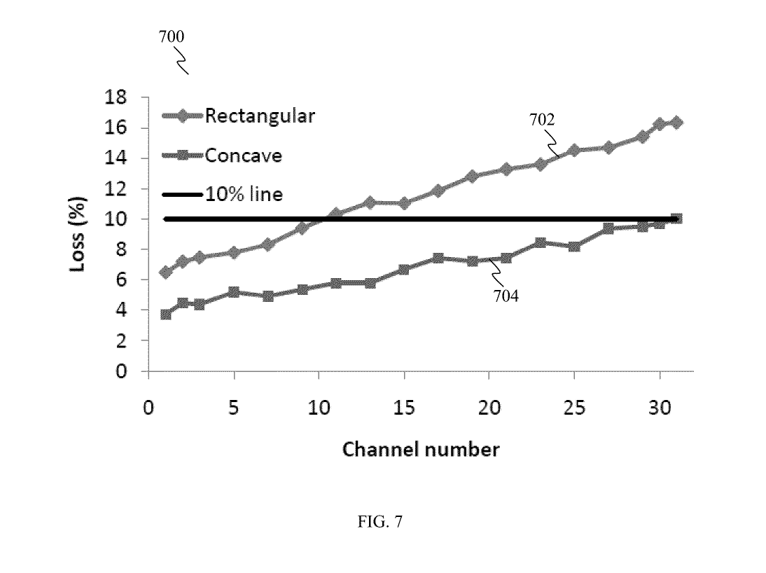

FIG. 7 shows a plot 700 for the result 702 for the overall insertion loss for a rectangular microchannel device, and the result 704 for the overall insertion loss for a biconcave microchannel device structure, as a function of the number of cascaded microchannels, providing a comparison of the insertion losses between the biconcave and the rectangular microchannel device structure geometry.

By considering an insertion loss of about 10% as the acceptable limit, the obtained result 704 shows that the biconcave microchannel array structure may enable or accommodate about 30 channels while keeping the loss at <10%. This may translate to an equivalent light-channel interaction length, Lₛᵤₘ, of about 900 μm, for individual microchannel lengths of about 30 μm. On the other hand, the result 702 shows that the rectangular microchannel array device structure may only accommodate up to 10 channels, leading to a maximum light-channel interaction length, Lₛᵤₘ, of about 300 μm for individual microchannel lengths of about 30 μm, before exceeding the 10% loss threshold.

The result 704 highlights that the cascaded biconcave microchannel array fiber device structure not only outperforms, for example in terms of the power throughput, by a factor of 14 over a device configuration based on a single long-length microchannel, but may also be able to increase the light-channel interaction length by a factor of 3 as compared to the rectangular microchannel array configuration counterpart.

The transmitted power characteristics of the microchannel fiber device structures with respect to the channel refractive indices (RI) may be determined, so as to illustrate variation with the refractive index. The channel refractive index refers to the refractive index of the fluid introduced into the channel.

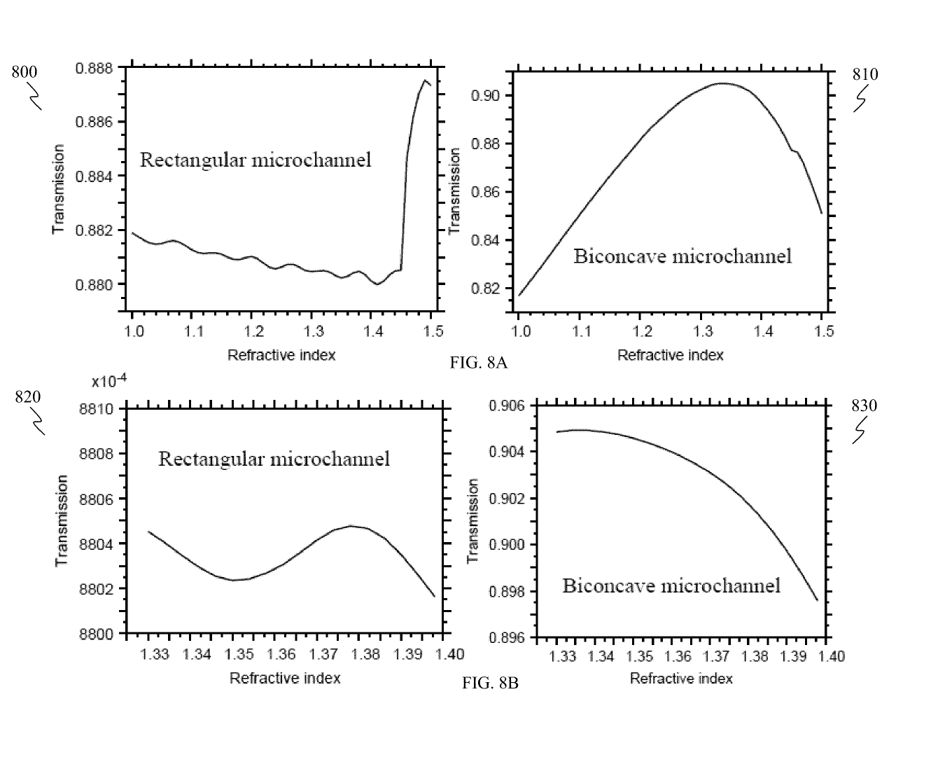

FIG. 8A shows a plot 800 of transmitted power for a rectangular microchannel device having a single rectangular microchannel and a plot 810 of transmitted power for a biconcave microchannel device structure having a single biconcave microchannel, as a function of refractive index change in the range of approximately 1-1.5. As may be observed from FIG. 8A, the overall transmitted power variation may be <1% and <10% for the respective optical devices having the rectangular microchannel and the biconcave microchannel, respectively.

FIG. 8B shows a plot 820 of transmitted power for a rectangular microchannel device having a single rectangular microchannel and a plot 830 of transmitted power for a biconcave microchannel device structure having a single biconcave microchannel, as a function of refractive index change in the range of approximately 1.333-1.4 corresponding to the RI of most bio-fluids. As may be observed from FIG. 8B, the transmission power variation is <1% in both the optical device having the rectangular microchannel and the optical device having the biconcave microchannel. The results indicate that the microchannel array fiber device structure of various embodiments may be suitable for biosensing applications.

As described above, a fiber device scheme that achieves low loss microchannel device configuration with large light-channel interaction surface and volume may be provided. The device concept of various embodiments may incorporate a series of cascaded microchannels with optimized dimensions, shapes and separations between them for maximum light-channel interaction and minimum insertion loss. In various embodiments, each microchannel may feature a biconcave shape in order to induce a focusing lens effect, enabling more light to be guided within the fiber core with less scattered light loss into the cladding.

Through numerical simulations, it is shown that the optimized biconcave microchannel array fiber device configuration may reduce the overall optical insertion loss by an order of magnitude as compared to a device configuration using a single long-length microchannel. In addition, the device scheme of various embodiments may accommodate a large number of microchannels to achieve a long effective light-channel interaction length, for example an effective light-channel interaction length of about 900 μm, while keeping the overall insertion loss to be <10%. For bio-applications where the refractive index (RI) range of interest lies within the range of about 1.333 to about 1.4, the device configuration may achieve <1% transmission power variation with the RI.

It should be appreciated that the geometry and arrangement of the microchannel(s) are not limited to that as described herein. For example, the microchannel may have an aspherical curved geometry for chromatic dispersion compensation so that the device may operate over a larger optical wavelength range. For a similar purpose, orientation of the microchannel(s) and separation of the microchannels may vary along the fiber. Further, individual microchannel cross sectional dimension may vary as it approaches the fiber core for purpose of ease of infiltration of fluids into the microchannel(s).

In various embodiments, the position of the microchannel(s) may be offset or even away from the fiber core to induce, for example, polarization-dependent effects or to effectuate cladding devices. This may mean that one or more microchannels may not pass through the fiber core physically. However, the microchannel(s) may be provided and remain in close proximity to the fiber core such that the optical field (or optical mode), propagating within the fiber core may remain overlap, though to a much lesser extent, with the microchannel(s). This is because the optical field propagating within the fiber core may extend slightly beyond the guiding core physical diameter. Therefore, a portion of the optical power associated with the light propagating in the fiber core may extend out of the fiber core, for example in the form of evanescent field. For example, for a single-mode optical fiber, the optical field mode diameter may be about 10 μm while the physical core diameter may be about 8 μm. Therefore, the microchannel(s) may be formed or arranged about 1 μm away from the fiber core, not intersecting the fiber core, while still able to achieve a small overlap with the propagating optical field.

In various embodiments, multiple microchannels may be stacked transversely across the fiber. The microchannel device of various embodiments may be integrated onto a chip for ease of handling as well as for control of material (e.g. fluid) flow within the microchannel(s).

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. An optical device comprising:
an optical fiber comprising a core for propagation of light and a cladding surrounding the core; and
at least one microchannel defined in the optical fiber extending at least partially through the cladding,
wherein the at least one microchannel has a concave-shaped surface arranged to interact with an optical field of the light.

2. The optical device as claimed in claim 1, wherein the at least one microchannel extends at least partially into the core, wherein the concave-shaped surface overlaps with the core.

3. The optical device as claimed in claim 1, wherein the at least one microchannel has another concave-shaped surface opposite to the concave-shaped surface.

4. The optical device as claimed in claim 1, wherein the at least one microchannel is defined orthogonally to the core.

5. The optical device as claimed in claim 1, further comprising an optical filter arranged adjacent to the at least one microchannel.

6. The optical device as claimed in claim 1, further comprising an optical gain medium arranged in the at least one microchannel.

7. The optical device as claimed in claim 1, further comprising at least one of a saturable absorber or a semiconductor material arranged in the at least one microchannel.

8. The optical device as claimed in claim 1, further comprising at least one of a magneto-optic material or an electro-optic material arranged in the at least one microchannel.

9. The optical device as claimed in claim 1, wherein the concave-shaped surface is aspherical.

10. The optical device as claimed in claim 1, wherein the concave-shaped surface has a radius of curvature of between about 10 μm and about 30 μm.

11. The optical device as claimed in claim 1, wherein a width of the at least one microchannel is between about 10 μm and about 100 μm.

12. The optical device as claimed in claim 1, wherein a length of the at least one microchannel is between about 20 μm and about 100 μm.

13. The optical device as claimed in claim 1, comprising:
a plurality of spaced apart microchannels defined in the optical fiber extending at least partially through the cladding,
wherein each microchannel of the plurality of spaced apart microchannels has a concave-shaped surface arranged to interact with the optical field of the light.

14. The optical device as claimed in claim 13, wherein the plurality of spaced apart microchannels are oriented at least substantially parallel to each other.

15. The optical device as claimed in claim 13, wherein a sum of respective lengths of the plurality of spaced apart microchannels is between about 40 μm and about 900 μm.

16. The optical device as claimed in claim 13, wherein a number of the plurality of spaced apart microchannels is between 2 microchannels and 30 microchannels.

17. The optical device as claimed in claim 13, wherein adjacent microchannels of the plurality of spaced apart microchannels are spaced apart by a separation of between about 10 μm and about 100 μm.

18. The optical device as claimed in claim 1, wherein the optical fiber comprises a doped fiber or a photonic crystal fiber.

19. A method of forming an optical device, the method comprising:
providing an optical fiber comprising a core for propagation of light and a cladding surrounding the core; and
forming at least one microchannel in the optical fiber extending at least partially through the cladding, the at least one microchannel having a concave-shaped surface arranged to interact with an optical field of the light.

20. A method for determining a parameter of a fluid, the method comprising:
providing a fluid into at least one microchannel defined in an optical fiber comprising a core for propagation of light and a cladding surrounding the core, the at least one microchannel extending at least partially through the cladding and having a concave-shaped surface;
providing a light into the core, wherein an optical field of the light interacts with the fluid;
determining a transmission characteristic of the light after interaction between the optical field and the fluid; and
determining a parameter of the fluid based on the determined transmission characteristic.
